(19) United States
(12) Patent Application Publication
(10) Pub. No.: US 2014/0262529 A1
(43) Pub. Date: Sep. 18, 2014

(54) ENCAPSULATED GAS FOR DRILLING AND COMPLETION FLUIDS

(71) Applicant: Baker Hughes Incorporated, Houston, TX (US)

(72) Inventors: Lirio Quintero, Houston, TX (US); Jonathan J. Brege, Spring, TX (US)

(73) Assignee: Baker Hughes Incorporated, Houston, TX (US)

(21) Appl. No.: 14/206,375

(22) Filed: Mar. 12, 2014

Related U.S. Application Data
(60) Provisional application No. 61/789,763, filed on Mar. 15, 2013.

(51) Int. Cl. C09K 8/38; E21B 7/00; C09K 8/58

(52) U.S. Cl. CPC C09K 8/38; C09K 8/58; E21B 7/00
USPC 175/69; 507/202; 507/102

(57) ABSTRACT

Gas-core microstructures, such as microbubbles, may be used in drilling and completion operations in the exploration and production of hydrocarbon fluids (e.g. oil and gas) from subterranean formations. The gas-core microstructures are dispersed in a base fluid such as water, oil or emulsions of water and oil, in accordance with the specific performance needs. Applications for fluids containing these gas-core microstructures include, but are not necessarily limited to, use as a spacers to control trapped annular pressure, use as low density drilling fluids, use as dual gradient drilling fluids and the delivery of chemicals downhole.

### CROSS-REFERENCE TO RELATED APPLICATION

This application claims the benefit of U.S. Provisional Patent Application Ser. No. 61/789,763, filed Mar. 15, 2013, incorporated herein by reference in its entirety.

### TECHNICAL FIELD

The present invention relates to wellbore operations fluids, such as drilling and completions fluids, used in the exploration for and production of hydrocarbons (e.g. oil and gas), and more particularly relates, in one non-limiting embodiment, to wellbore operations fluids having gas-core microstructures which impart variable density to the fluids.

### BACKGROUND

Hydrocarbons such as oil, natural gas, etc., may be obtained from a subterranean geologic formation, e.g., a reservoir, by drilling a well that penetrates the hydrocarbon-bearing formation. Drilling fluids used in the drilling of subterranean oil and gas wells along with other drilling fluid applications and drilling procedures are known. In rotary drilling there are a variety of functions and characteristics that are expected of drilling fluids, also known as drilling muds, or simply “muds”. The various functions of a drilling fluid include, but are not necessarily limited to, cooling and lubricating the bit, lubricating the drill pipe, carrying the cuttings and other materials from the hole to the surface, and exerting a hydrostatic pressure against the borehole wall to prevent the flow of fluids from the surrounding formation into the borehole.

Drilling fluids are typically classified according to their base fluid. In water-based muds, solid particles are suspended in water or brine. Oil can be emulsified in the water which is the continuous phase. Brine-based drilling fluids, of course, are a water-based mud (WBM) in which the aqueous component is brine. Oil-based muds (OBM) are the opposite or inverse. Solid particles may be suspended in oil, and water or brine is emulsified in the oil and therefore the oil is the continuous phase. Oil-based muds can be either all-oil based or water-in-oil macroemulsions, which are also called invert emulsions. In oil-based mud, the oil may consist of any oil that may include, but is not limited to, diesel, mineral oil, esters, or alpha-olefins. OBMs as defined herein also include synthetic-based fluids or muds (SBMs), in which the oil or oils present are synthetically produced rather than refined from naturally-occurring materials. SBMs often include, but are not necessarily limited to, olefin oligomers of ethylene, esters made from vegetable fatty acids and alcohols, ethers and polyethers made from alcohols and polyalcohols, paraffinic, or aromatic, hydrocarbons alkyl benzenes, terpenes and other natural products and mixtures of these types. OBMs and SBMs are also sometimes collectively referred to as “non-aqueous fluids” (NAFs).

Damage to a reservoir is particularly harmful if it occurs while drilling through the pay zone or the zone believed to hold recoverable oil or gas. In order to avoid such damage, a different fluid—known as a “drill-in” fluid—may be pumped through the drill pipe while drilling through the pay zone.

Another type of fluid used in oil and gas wells is a completion fluid. A completion fluid is pumped down a well after drilling operations are finished and during the completion phase. Drilling mud typically is removed or displaced from the well using a completion fluid, which may be a clear brine. Then, the equipment required to produce fluids to the surface is installed in the well. A completion fluid must have sufficient density to maintain a differential pressure with the wellbore, which controls the well and to maintain the filter cake. The viscosity of a completion brine typically is maintained using polymers, such as starches, derivatized starches, gums, derivatized gums, and cellulosics. Viscoelastic surfactants may also be used to viscosify drilling fluids, drill-in fluids, completion fluids, and the like.

Drilling fluid density, also called “mud weight”, controls the hydrostatic pressure in a wellbore and helps prevent unwanted flow into the well. The drilling fluid weight also helps prevent collapse of the casing and the open hole. Excessive mud weight can cause lost circulation by propagating and then filling fractures in the formation rock.

Annular pressure is fluid pressure in the annulus between the tubing and the casing or between two strings of casing. Completion fluids can be trapped in the annulus between two packers. Additionally, in deepwater or other subsea completed wells, fluids, usually spacers or drilling fluids, may be trapped in casing annuli above the top-of-cement and below the wellhead. A spacer is a fluid used in various operations in the wellbore construction. Spacers are fluids designed to displace to dissimilar fluids such as displacement of OBM to WBM or to help in the removal of drilling fluids before a primary cementing operation. Typically spacers are prepared with specific fluid characteristics, such as density and viscosity, to displace the drilling fluid to enable placement of a complete cement sheath. When these trapped fluids are heated by the passage of warm produced fluids, thermal expansion can create very high pressures (10,000-12,000 psi or more (69 MPa-83 MPa or more)) and cause the collapse of casing and tubing strings. It would be desirable if methods or compositions could be devised to help mitigate trapped annular pressure.

If the subterranean formation is subnormal, relatively lower density fluids may be used, which may include, but not necessarily be limited to, air, other gases, mist, foams, aerated drilling fluids, oil-in-water emulsion drilling or completion fluids or low density oil-based drilling fluids. However, it would be useful if other ways of controlling the density of drilling fluids could be devised to give operators more degrees of control.

Dual gradient or multiple or variable density drilling fluids are known. Prior variable density drilling fluids primarily concerned the use of a highly compressible gas (e.g. air or nitrogen) as a free phase in the fluid. Limited, if any, efforts are made during conventional air, mist or foam drilling to control the expandability of the bulk fluid or to adjust or engineer the compressibility of the fluid other than managing the ratio of air or other gas to the fluid. Other proposals to employ a virtual multiple gradient fluid include so-called dual gradient drilling. This method would use two columns of different density fluids. One column would be essentially static, while the second fluid density is circulated below the seafloor. During drilling, the vertical height of the column in the well bore would change as the well is deepened and the resulting bulk average fluid density along the wellbore would thus vary with depth.

Typical “single gradient” fluids used today include multiple components (base fluid, various solids and additives). The density of the base fluids is known to vary with temperature and to some degree with pressure. While these density changes are often accounted for during the mathematical modeling of the fluid pressures in the wellbore, the density changes resulting from this behavior is not sufficient to change the design of the wellbore with respect to pore and fracture pressure profiles, as well as position and number of casing strings.

Controlled variable density drilling fluids are described in U.S. Pat. No. 8,343,894 (Baker Hughes Incorporated; Watkins, et al.) which discloses fluid systems containing elements to provide changes in bulk fluid density in response to various environmental conditions. One environmental driver to the variable density is pressure; other environmental drivers include, but are not limited to, temperature or changes in chemistry. The variable density of the fluid is beneficial for controlling sub-surface pressures within desirable pore pressure and fracture gradient envelopes. The variability of fluid density permits construction and operation of a wellbore with much longer hole sections than when using conventional single gradient fluids.

It is desirable if other variable density fluids were devised where the properties of the fluid could be designed to fit the requirements of the wellbore operation and the subterranean formations being drilled. It would also be desirable if a variable density fluid composition could be devised that can be recirculated in the current well and/or reused on a second or subsequent well.

It would also be desirable if methods and compositions were devised to deliver chemicals downhole for a variety of purposes, one non-limiting example being to deliver a reactant to a predetermined location to cause a reaction with another or a second reactant, such as at a remote location.

### SUMMARY

In one non-limiting embodiment there is provided a wellbore operations fluid that includes a base fluid selected from the group consisting of water, oil or an emulsion, and a plurality of gas-core microstructures. The gas-core microstructures in turn each comprise a gas-filled core and a shell. The shell may be a shell selected from the group consisting of surfactant-based single-wall shells, surfactant-based multiple-wall shells, and rigid polymer-based shells which are not an elastomer. The wellbore operations fluid is selected from the group consisting of drilling fluids, drill-in fluids and completion fluids.

Additionally, there is provided, in one form, a method for introducing encapsulated gas into a subterranean structure selected from the group consisting of a wellbore and a subterranean formation, where the method comprises pumping a wellbore operations fluid through a wellbore, where the fluid comprises a base fluid selected from the group consisting of water, oil or an emulsion, and a plurality of gas-core microstructures therein. The gas-core microstructures are as noted above. Again, the wellbore operations fluid is configured to be a fluid selected from the group consisting of drilling fluids, drill-in fluids and completion fluids. The method involves performing at least one additional step, which includes, but is not necessarily limited to: controlling trapped annular pressure, controlling gas migration in cement, delivering the gas in the gas-filled core to a predetermined location, releasing the gas in the gas-filled core to a predetermined location and reacting the gas with another reactant at a predetermined location, drilling a borehole with a low density drilling fluid having a density from about 6.0 to about 8.3 ppg (about 0.7 to about 1 kg/liter); drilling a borehole with the wellbore operations fluid, where the wellbore operations fluid is at least a dual gradient drilling fluid, and combinations thereof, but which may have more than two gradients.

### DETAILED DESCRIPTION

It has been discovered that wellbore operations fluids containing gas-core microstructures may be usefully formulated as a spacer for trapped annular pressure control. Such fluids containing gas-core microstructures may also be suitable as low density drilling fluids, lightweight cements or as dual gradient or variable gradient drilling fluids.

Trapped annular pressure is generated within an annulus by thermal expansion of wellbore fluids, typically during production. This occurs when cement is not circulated back to surface and the drilling fluids or spacers become trapped in the annulus between the top of cement and the wellhead. Trapped annular pressure is due to the thermal expansion of fluids trapped in casing annuli, most commonly between the top of cement and the wellhead. The pressure build-up is usually due to the heat brought up by produced fluids, but can even be triggered by the circulation of hot drilling fluids while drilling an HTHP well. The common practice in land wells is to relieve the annular pressure by bleeding off some fluid through a casing-head valve. However, this practice cannot apply in the majority of subsea completed wells.

As noted, in the case of trapped annular pressure, borehole fluids (oil, water, and gas) may cause heating and thermal expansion of the trapped annular fluid (e.g. an oil-based mud). Due to the physical entrapment of the fluid, this thermal expansion may eventually cause fracture of the casing and tubing strings. One way to overcome this problem is to use gas-core microstructures in nano- or micron-size to act as pressure absorbents. That is, the gas-core microstructure-containing fluids may have tunable or customizable thermal pressurization coefficients. The gas-core microstructures may absorb the expansion and mitigate the effects of trapped annular pressure.

Another application for the wellbore operations fluids containing gas-core microstructures is for the control of gas migration in lightweight cement. Cement is often entrained with gases to reduce its density. However, these gases are often prone to migration before the cement sets. Gas migration is defined herein as gas entry into a cemented annulus, creating channels and flow path for formation fluids, including hydrocarbons, within the wellbore. This can cause gas and liquid flow in the annulus. It can be detected by cement bond logs or by observing changes in pressures. Formulating the cement with a gas-core microstructure-containing fluid reduces its density similar to conventional techniques but without the risk of gas migration before cement setting. Thus, gas migration is prevented and/or inhibited using the gas-core microstructure-containing fluids herein.

In another application, the gas-core microstructure-containing fluids could be used as a gas delivery vehicle or microreactor downhole. A controlled release of the encapsulated gas could deliver chemicals or materials to specific sites such as areas of hydrate formation to inhibit or prevent the formation of gas hydrates. Alternatively, the gas within the gas core may be released at a predetermined location to react the gas with another or a second reactant at a predetermined location to create a product in situ that is otherwise more difficult to place. In one non-limiting example, the reaction could be exothermic to generate heat downhole, such as to cause an effect triggered by heat, including, but not necessarily limited to, melting a polymer plug covering an orifice or disintegrating an asphaltene obstruction.

The gas-core microstructures can be engineered to have a soft or hard shell depending on the application. In general the “soft shell” gas-core microstructures are easier to prepare and have higher compressibility of the shell, and they generally have a more limited lifetime under pressure—a relatively faster diffusion of gas out of the shell without additional encapsulation. It should be understood that the above-described methods may be used to fabricate structures having more than one polymer layer or shell. The “hard shell” gas-core microstructures are more stable at high pressure and have relatively low gas diffusion as compared to the soft shell microstructures, but they are less compressible.

The gas-core microstructures have two basic parts: a gas-filled core and a shell surrounding the core. The gas in the gas-filled core may be any suitable gas, including, but not necessarily limited to, air, relatively pure oxygen, relatively pure nitrogen, a noble gas, helium, nitrogen, carbon dioxide, light hydrocarbons, and mixtures thereof. As used herein, the term “relatively pure” means at least 95 vol % pure; alternatively at least 98 vol % pure.

The shell may be of three basic types: surfactant-based single-wall shells; surfactant-based multiple-wall shells and rigid polymer-based shells which are not an elastomer or pliable or compliant. The gas-core microstructures should be stable at high pressure (up to about 1021 atm (about 15,000 psi)), high temperature (up to about 100° C.), high salt concentration (up to about 10 wt %) and low pH (about 4-8). In general, relatively soft, single-wall microbubbles may not survive above a few atmospheres. Multiple-wall shells have high shell stiffness and thus relatively much longer lifetimes. Gas-core microstructures with hard polymer shells are expected to withstand higher pressures.

The expected average particle size range of the gas-core microstructures is from about 100 nm independently to about 500 μm; alternatively from about 500 nm independently to about 200 μm; and in another non-limiting embodiment alternatively from about 1 μm independently to about 100 μm. The word “independently” is used herein to mean that any lower threshold may be combined with any upper threshold to give an acceptable alternative range. It is important that the gas-core microstructures are sufficiently small to be introduced downhole via pumping and sufficiently durable as to not be sheared and broken by the shearing forces at the drill bit.

The surfactant-based gas-core microstructures may be made by a process of combining water, surfactant, and stabilizer, where the surfactants are from the group consisting of non-ionic, anionic, cationic, zwitterionic and amphoteric surfactants, and combinations thereof. Others suitable surfactants include dimeric or gemini surfactants, extended surfactants, silicone surfactants, silicate surfactants, Janus surfactants, cleavable surfactants and combinations thereof. Suitable nonionic surfactants include, but are not necessarily limited to, alkyl polyglycosides, sorbitan esters, methyl glucoside esters, alcohol ethoxylates, or polyglycol esters. In one non-restrictive version, polyglycol esters are particularly suitable, and in another non-limiting embodiment there is an absence of alkyl polyglycosides. Suitable cationic surfactants include, but are not necessarily limited to, arginine methyl esters, alkanolamines and alkylenediamides. Suitable anionic surfactants include, but are not necessarily limited to, alkali metal alkyl sulfates, alkyl or alkylaryl sulfonates, linear or branched alkyl ether sulfates and sulfonates, alcohol polypropoxylated and/or polyethoxylated sulfates, alkyl or alkylaryl disulfonates, alkyl disulfates, alkyl sulphosuccinates, alkyl ether sulfates, linear and branched ether sulfates, and mixtures thereof. In one non-limiting embodiment at least two surfactants in a blend may be used to create single phase microemulsions, as well as the other spacer fluids. Suitable surfactants may also include surfactants containing a non-ionic spacer-arm central extension and an ionic or nonionic polar group. The non-ionic spacer-arm central extension may be the result of polypropoxylation, polyethoxylation, or a mixture of the two, in non-limiting embodiments.

Suitable stabilizers include, but are not necessarily limited to any of the surfactant molecules listed. Suitable examples include, but are not necessarily limited to, silicone or silicate surfactants in combination with acidic molecules to form a self-assembling structure, which could form a shell around the gas-core. Suitable specific stabilizers include, but are not necessarily limited to, sodium dodecyl sulfate (SDS), polyvinylalcohol (PVA), poly-alkylamine hydrochloride (PAH) in a sodium carbonate or sodium bicarbonate solution.

Suitable polymers for polymer-based gas-core or surfactant/polymer-based gas-core include, but are not necessarily limited to, general polymers and copolymers such as polysilane, polyvinyl alcohol, poly(methyl methacrylate), polystyrene, polypropylene, polyethylene, polytetrafluoroethylene, polyvinyl chloride, poly divinylbenzene, polyamide, polyester, polylactide and the like.

The surfactant-based gas-core microstructures may be made by a process involving adding gas or air to a liquid phase with surfactant or polymers during high-shear mixing or sonication. Typical equipment used includes the Ultra Turrax homogenizer operated at rotation speeds between 500 and 15000 rpm.

More controlled methods of preparation include one described in U.S. Patent Application Publication No. 2012/0328529 A1 incorporated herein by reference in its entirely; see FIG. 1A and the description thereof in paragraphs [0019] and [0046] of this publication. Any device that involves injection of gas through an orifice or capillary tube into a liquid (in open or closed container) may be used to form gas-core microstructures, i.e. gas micro bubbles. The stabilizer (surfactants and/or polymers) may already be present in the aqueous phase or could be injected using a second orifice of a capillary. The average size and the size distribution can be controlled by the flow rate of the injection, the proportion of gas/liquid, the concentration of stabilizer and other additives.

Other information about making gas-core microstructures may be found in S. Y. Sim, et al., “Fabrication of Polymeric Nanoparticles and Microbubbles”, poster presented to Advanced Energy Consortium, 2010, incorporated herein by reference in its entirety, which methods are outlined below.

There are a number of known methods to manufacture polymer hollow microspheres:
1. Multiple Emulsion/solvent evaporation method
   Challenges:
   a. W₁/O/W₂ emulsions are thermodynamically unstable
   b. leakage of contents from the inner aqueous phase
   c. flocculation of the inner aqueous phase and multiple emulsion droplets
2. Emulsification/Freeze-Drying method
   Challenges:
   a. hole size is not uniform
   b. second step of the preparation (surface hole closing)
3. Dynamic Swelling method based on seed polymerization
   Challenges:
a. Limited to cross-linking agents
b. Labor intensive, time consuming

In one non-limiting embodiment of the multiple emulsion method, rigid shell microbubbles may be fabricated from poly(methyl methacrylate) (PMMA) and polystyrene (PS) using a W₁/O/W₂ multiple emulsion/solvent evaporation method, where W₁ refers to a first water phase, O refers to an oil phase and W₂ refers to a second water phase where a typical reaction composition is as follows:
W₁—water or ammonium carbonate solution and a primary emulsion stabilizer (sodium dodecyl sulfate (SDS) or polyvinylalcohol (PVA)),
O—PS (Mw 280,000), PMMA (Mw 15,000 and 120,000)/methylene chloride (CH₂Cl₂), where Mw refers to mass average molar mass, or weight average molecular weight, and
W₂—aqueous solution with secondary emulsion stabilizer (PVA).

The W₁ phase is introduced into a container with the O phase, where the container was in an ice bath and equipped with a sonicator (probe type) to form a W₁/O emulsion. The shell is a combination of polymer and surfactant. This emulsion was then introduced into the W₂ phase with homogenization or stirring to form a W₁/O/W₂ multiple emulsion. The emulsion was subjected to solvent evaporation or solvent extraction, then centrifugation and washing with deionized (DI) water, frozen and heat drying to give PMMA- or PS-based hollow particles as models for rigid shell microbubbles.

One non-limiting embodiment of the emulsification/freeze-drying method begins with PS beads in water. A swelling solvent, such as styrene, toluene or the like, is introduced, the PS beads swell as they absorb solvent. In a separate container, PMMA and toluene are introduced into water and SDS and stirred to form a PMMA emulsion in water. These two formulations are then mixed and frozen with liquid nitrogen. Next the solvent is evaporated in the presence of air to give hollow spheres that have small holes. The surface holes can be closed by either 1) thermal annealing or 2) by using a second solvent swelling step. (1) For hollow particles of PS and PMMA, thermal annealing at slightly above the glass transition (Tg) of the polymer closes large openings, such as adding styrene into PS open hollow particles in suspension and annealing at 40° C. for one hour. (2) Introduction of a second swelling solvent induces a higher interfacial tension in the interior of the particle, pulling the hole closed. For instance, PS beads having a size of 1 μm in a proportion of 10 wt % in water may have a swelling solvent of 0.1 ml styrene added. PMMA (10 wt % in toluene) and a SDS solution (2 wt %) can close hollow spheres of less than 10 μm in size after soaking in an aqueous solution of 2% (v/v) toluene at 40° C. for 1 hour.

In another non-restrictive version, microsized, monodisperse, cross-linked polystyrene/polyethylene glycol dimethacrylate (PS/PEGDM) and polystyrene/poly(divinylbenzene) (PS/PDVB) hollow particles can be prepared by seed polymerization using swollen PS particles by a method such as the following:
1) PS particles absorb toluene and DVB by the dynamic swelling method,
2) As the seeded polymerization proceeds, the PDVB molecules precipitate in swollen PS beads through cross-linking,
3) They are trapped near the interface by surface coagulation and gradually piled at the inner surface, resulting in a cross-linked PDVB shell,
4) PS and DVB are gradually repelled to the inside,
5) After the completion of the polymerization, the toluene and dissolved PS are trapped by the PDVB shell, and
6) Toluene evaporates by drying, and PS clings uniformly to the inner wall of the shell.

Microbubbles, such as the above, are used to enhance the acoustic response of oil microdomains by introducing them into underground formations. Microbubbles are also known for use in medical ultrasound imaging, but are now being studied for therapeutic applications for drug or gene delivery. Some of these microbubbles are expected to be useful herein as the gas-core microstructures. V. Liu, et al. in Encapsulated Ultrasound Microbubbles: Therapeutic Application in Drug/Gene Delivery, Journal of Controlled Release, Vol. 114 (2006), pp. 89-99 (incorporated herein by reference in its entirety) mention the following sizes and materials in Table I used in the gas core and shells for a variety of microbubbles. These microbubbles can be destroyed using focused application of ultrasound and their sensitivity is noted even though for a downhole application the ultrasound generator would have to be located relatively close to the microbubbles to burst them using currently available technology.

TABLE I
Comparison of Various Microbubbles

| | Bubble | | | Micro- |
|---|---|---|---|---|
| | size mean | | | bubble |
| Agent | (target) | Gas | Shell composition | destruction |
| Albunex | 4.5 μm | Air | Albumin | Sensitive |
| | (1-10 μm) | | | |
| Levovist | 2-3 μm | Air | none—bubbles | Sensitive |
| | (2-8 μm) | | adhere to | |
| | | | galactose | |
| | | | microparticles | |
| Echogen | 2-5 μm | Perfluoropentane | Stabilized | Resistant |
| | (1-30 μm) | | surfactant | |
| Sonogen | 2-5 μm | Perfluoropentane | Anionically- | Resistant |
| | (1-30 μm) | | charged surfactant | |
| Optison | 4.7 μm | Perfluoropentane | Albumin | Sensitive |
| | (1-10 μm) | | | |
| Definity | 1.4 μm | Perfluoropentane | Phospholipid | Sensitive |
| | (1-10 μm) | | | |
| Imagent | 5 μm | Perfluoropentane | Perfluoropentane | Sensitive |
| Sonovue | 2.5 μm | Sulfur | Phospholipids | Sensitive |
| | (1-10 μm) | hexafluoride | | |
| PB 127 | 4.0 μm | Nitrogen | Biodegradable | Designable |
| | (3-5 μm) | | polymer bilayer | |
| NC100100 | 3.4 μm | Unspecified | Unknown | Sensitive |
| | | perfluorocarbon | | |
| AI-700 | 2 μm | Perfluorocarbon | Synthetic polymer | Resistant |

In one non-limiting embodiment the microbubbles may be liposome-loaded, but this appears to be more important for use as a drug delivery platform as reported by B. Geers, et al. in “Self-Assembled Liposome-Loaded Microbubbles: The Missing Link for Safe and Efficient Ultrasound Triggered Drug-Delivery,” Journal of Controlled Release, Volume 152 (2011) pp. 249-256 (incorporated herein by reference in its entirety). The Introduction of this article notes that microbubbles are gas filled microspheres which are approved for diagnostic ultrasound contrast imaging by the FDA. Such bubbles, a few microns in size, are usually filled with a hydrophobic gas and are stabilized by a surfactant (lipid, protein or polymer) shell, to enhance their shelf life and time in circulation. Because of the difference in density between the gas core of the microbubble and the surrounding fluid, microbubbles can start to oscillate when subjected to high frequency (about 1 to about 10 MHz) ultrasound. This “cavitation” of microbubbles has been intensively studied by means of high speed optical imaging and can be divided into respectively stable and inertial cavitation. In an ultrasound field with a low acoustical pressure microbubbles are stably cavitating and will oscillate around a given diameter. Inertial cavitation on the other hand occurs at higher acoustical pressures. The movement of the microbubbles becomes more violent which leads to destruction of the micro bubbles.

Polymer-lipid microbubbles (PLBs) may be generated by microfluidic flow-focusing devices to form long-lasting hybrid particles as described by K. Hettiarachichi, et al. in “Polymer-Lipid Microbubbles for Biosensing and the Formation of Porous Structures,” Journal of Colloid and Interface Science, Vol. 44 (2010) pp. 521-527, incorporated herein by reference in its entirety. The specific PLB construct developed by the authors is an elastic gas-filled microsphere with a polydimethylsiloxane (PDMS) shell containing phospholipids conjugated to functionalized polyethyleneglycol (PEG). Digital “droplet-based” microfluidics technology enables control of particle composition, size, and polydispersity (σ<10%). Use of PDMS as a shell component improves the functionality and stability (a lifetime of greater than 6 months) of the hybrid particles due to the thermally maneuverable solidification process. With a gas core, they serve as a template material for creating three-dimensional porous structures and surfaces, requiring no cumbersome post-processing removal steps. Previously, the lifetime of typical microbubble lipospheres was been limited to a few hours upon production due to gas exchange and dissolution. Armored bubbles that are encapsulated by a close-packed monolayer of solid particles driven by chemical assembly have improved stability by suppressing gas dissolution.

Hettiarachichi, et al. describe that microfluidic flow-focusing based methods provide a high-level of control over reaction conditions, enabling the synthesis of multi-layer lipospheres and polymer microspheres with narrow sample size distributions. In this work the elasticity of PDMS was combined with the functional characteristics of polyethyleneglycol (PEG)-lipid derivatives to create a new class of stable and compressible polymer-lipid microbubbles incorporating PDMS as a shell component that improves the functionality and stability (greater than 6 months) of the hybrid particles due to the thermally maneuverable solidification process. The use of PDMS as a component in the continuous phase also allows for the creation of porous and functional PDMS microfluidic channel surfaces. With a gas core, the particles are compressible and have the potential to respond to acoustic and ultrasound excitations. Furthermore they serve as a non-sacrificial template material for creating porous elastomers, requiring no cumbersome post-processing removal steps. Deformability can also be tuned by adjusting the PDMS cross-linking density or entrapped fluid properties.

Aphrons differ from the gas-core microstructures described herein in that aphrons are stabilized by a surfactant bilayer. They are similar to vesicles. The wellbore operations fluids herein have an absence of aphrons and vesicles.

When the gas-core microstructures are used as component delivery vehicles or for downhole micro-reactor, it is expected that they may be present in the base fluid in a proportion in the range of from about 0.1 vol % independently to about 50 vol %; alternatively from about 0.1 vol % independently to about 10 vol %. When the gas-core microstructures are used in a base fluid to make a low density drill-in fluid, it is expected that they may be present in a proportion range of from about 3 vol % independently to about 50 vol %; alternatively from about 3 wt % independently to about 10 wt %. As noted, the gas-core microstructures may also be used to control trapped annular pressure, control gas migration in cement, in drilling a borehole with the wellbore operations fluid, where the wellbore operations fluid is configured to be at least a dual gradient drilling fluid. There is no special or critical way that the gas-core microstructures may be or should be added to wellbore operations fluids.

The base fluids suitable herein may be water, oil or an emulsion of the two, including, but not necessarily limited to, O/W emulsions, W/O emulsions and bicontinuous emulsions. The base fluids may suitably be any of the base fluids previously discussed with respect to drilling fluids, drill-in fluids and completion fluids.

It should be understood that in the practice of the compositions and methods described herein, the drilling fluid and other wellbore operations fluids may also include any of the functional additives and components known to those of skill in the art, such as antioxidants, bentonites, suspended solid weighting agents (including, but not necessarily limited to, barite, hematite, calcium carbonate, siderite, ilmenite, and the like and combinations thereof), gums, water soluble polymers, viscosity modifying agents, breakers, emulsifiers, surfactants, lubricants, thinners, circulation control additives, purified paraffins, isomerized olefins, salts for brine formation, and the like.

In the foregoing specification, the invention has been described with reference to specific embodiments thereof as effective in providing gas-core microstructures in fluids to give wellbore operations fluids suitable to accomplish various tasks in a wellbore and/or subterranean formation. However, it will be evident that various modifications and changes can be made thereto without departing from the broader spirit or scope of the invention as set forth in the appended claims. Accordingly, the specification is to be regarded in an illustrative rather than a restrictive sense. For example, specific combinations of polymers surfactants, solvents, gases, base fluids, and other components falling within the claimed parameters, but not specifically identified or tried in a particular composition, are anticipated to be within the scope of this invention.

The present invention may suitably comprise, consist of or consist essentially of the elements disclosed and may be practiced in the absence of an element not disclosed. For example, a wellbore operations fluid may consist of or consist essentially of a base fluid selected from the group consisting of water, oil and/or an emulsion and a plurality of gas-core microstructures. The gas-core microstructures may in turn each consist of or consist essentially of a gas-filled core and a shell selected from the group consisting of surfactant-based single-wall shells, surfactant-based multiple-wall shells, and rigid polymer-based shells which are not an elastomer, where the wellbore operations fluid is a fluid selected from the group consisting of drilling fluids, drill-in fluids and completion fluids.

In another non-limiting embodiment there is provided a method for introducing encapsulated gas into a subterranean structure selected from the group consisting of a wellbore and a subterranean formation, where the method consists of or consists essentially of pumping through a wellbore a wellbore operations fluid consisting of or consisting essentially of that described above. The method further consists of or consists essentially of performing at least one additional step selected from the group consisting of controlling trapped annular pressure; controlling gas migration in cement; delivering the gas in the gas-filled core to a predetermined location; releasing the gas in the gas-filled core to a predetermined location and reacting the gas with another reactant at a predetermined location; drilling a borehole with a low density drilling fluid having a density from about 6 to about 8.3 ppg (about 0.7 to about 1 kg/liter); drilling a borehole with the wellbore operations fluid, where the wellbore operations fluid is configured to be at least a dual gradient drilling fluid; and combinations thereof.

The words “comprising” and “comprises” as used throughout the claims, are to be interpreted to mean “including but not limited to” and “includes but not limited to”, respectively.

What is claimed is:

1. A method for introducing encapsulated gas into a subterranean structure selected from the group consisting of a wellbore and a subterranean formation, the method comprising:
pumping through a wellbore a wellbore operations fluid comprising:
a base fluid selected from the group consisting of water, oil and an emulsion of water and oil;
a plurality of gas-core microstructures each comprising:
a gas-filled core;
a shell selected from the group consisting of:
surfactant-based single-wall shells;
surfactant-based multiple-wall shells; and
rigid polymer-based shells which are not an elastomer;
where the wellbore operations fluid is selected from the group consisting of drilling fluids, drill-in fluids and completion fluids; and
performing at least one additional step selected from the group consisting of:
controlling trapped annular pressure;
controlling gas migration in cement;
delivering the gas in the gas-filled core to a predetermined location;
releasing the gas in the gas-filled core to a predetermined location and reacting the gas with another reactant at a predetermined location;
drilling a borehole with a low density drilling fluid having a density from about 6.0 to about 8.3 ppg (about 0.7 to about 1 kg/liter);
drilling a borehole with the wellbore operations fluid, where the wellbore operations fluid is at least a dual gradient drilling fluid; and
combinations thereof.

2. The method of claim 1 where the one additional step is selected from the group consisting of:
delivering the gas in the gas-filled core to a predetermined location;
releasing the gas in the gas-filled core to a predetermined location and reacting the gas with another reactant at a predetermined location; and
combinations thereof; and
where the proportion of gas-core microstructures in the wellbore operations fluid ranges from about 0.1 to about 50 vol %.

3. The method of claim 1 where the one additional step is drilling a borehole with a low density drilling fluid and the proportion of gas-core microstructures in the wellbore operations fluid ranges from about 3 vol % to about 50 vol %.

4. The method of claim 1 where the gas-core microstructures have an average particle size from about 100 nm independently to about 500 μm.

5. The method of claim 1 where the surfactants in the surfactant-based shells are selected from the group consisting of non-ionic surfactants, anionic surfactants, cationic surfactants, zwitterionic surfactants, amphoteric surfactants, dimeric or gemini surfactants, extended surfactants, silicone surfactants, Janus surfactants, cleavable surfactants and combinations thereof.

6. The method of claim 1 where the polymers in the rigid polymer-based shells are selected from the group consisting of aromatic polyesters, acrylate polymers, polystyrene, poly(methyl methacrylate), polyethylene glycol dimethacrylate, polystyrene/poly(divinylbenzene), polymer-lipids, polydimethylsiloxane, polyethyleneglycol, fluoropolymers, PVA polymers, and combinations thereof.

7. A method for introducing encapsulated gas into a subterranean structure selected from the group consisting of a wellbore and a subterranean formation, the method comprising:
pumping through a wellbore a wellbore operations fluid comprising:
a base fluid selected from the group consisting of water, oil and an emulsion of water and oil;
a plurality of gas-core microstructures each consisting of:
a gas-filled core;
a shell selected from the group consisting of:
surfactant-based single-wall shells;
surfactant-based multiple-wall shells; and
rigid polymer-based shells which are not an elastomer,
where the gas-core microstructures have an average particle size from about 100 nm independently to about 500 μm;
where the wellbore operations fluid is selected from the group consisting of drilling fluids, drill-in fluids and completion fluids; and
performing at least one additional step selected from the group consisting of:
controlling trapped annular pressure;
controlling gas migration in cement;
delivering the gas in the gas-filled core to a predetermined location;
releasing the gas in the gas-filled core to a predetermined location and reacting the gas with another reactant at a predetermined location;
drilling a borehole with a low density drilling fluid having a density from about 6.0 to about 8.3 ppg (about 0.7 to about 1 kg/liter);
drilling a borehole with the wellbore operations fluid, where the wellbore operations fluid is at least a dual gradient drilling fluid; and
combinations thereof.

8. The method of claim 7 where the one additional step is selected from the group consisting of:
delivering the gas in the gas-filled core to a predetermined location;
releasing the gas in the gas-filled core to a predetermined location and reacting the gas with another reactant at a predetermined location; and
combinations thereof; and
where the proportion of gas-core microstructures in the wellbore operations fluid ranges from about 0.1 to about 50 vol %.

9. The method of claim 7 where the one additional step is drilling a borehole with a low density drilling fluid and the proportion of gas-core microstructures in the wellbore operations fluid ranges from about 3 vol % to about 50 vol %.

10. The method of claim 7 where the surfactants in the surfactant-based shells are selected from the group consisting of non-ionic surfactants, anionic surfactants, cationic surfactants, zwitterionic surfactants, amphoteric surfactants, dimeric or gemini surfactants, extended surfactants, silicone surfactants, Janus surfactants, cleavable surfactants and combinations thereof.

11. The method of claim 7 where the polymers in the rigid polymer-based shells are selected from the group consisting of aromatic polyesters, acrylate polymers, polystyrene, poly(methyl methacrylate), polyethylene glycol dimethacrylate, polystyrene/poly(divinylbenzene), polymer-lipids, polydimethylsiloxane, polyethyleneglycol, fluoropolymers, PVA polymers, and combinations thereof.

12. A wellbore operations fluid comprising:
a base fluid selected from the group consisting of water, oil, and an emulsion of water and oil;
a plurality of gas-core microstructures each comprising:
a gas-filled core;
a shell selected from the group consisting of
surfactant-based single-wall shells;
surfactant-based multiple-wall shells; and
rigid polymer-based shells which are not an elastomer;
where the wellbore operations fluid is selected from the group consisting of drilling fluids, drill-in fluids and completion fluids.

13. The wellbore operations fluid of claim 12 where the wellbore operations fluid is a low density drilling fluid having a density from about 6 to about 8.3 ppg (about 0.7 to about 1 kg/liter); and where a proportion of gas-core microstructures in the wellbore operations fluid ranges from about 3 vol % to about 50 vol %.

14. The wellbore operations fluid of claim 12 where the gas-core microstructures have an average particle size from about 100 nm independently to about 500 μm.

15. The wellbore operations fluid of claim 12 where the surfactants in the surfactant-based shells are selected from the group consisting of non-ionic surfactants, anionic surfactants, cationic surfactants, zwitterionic surfactants, amphoteric surfactants, dimeric or gemini surfactants, extended surfactants, silicone surfactants, Janus surfactants, cleavable surfactants and combinations thereof.

16. The wellbore operations fluid of claim 12 where the polymers in the rigid polymer-based shells are selected from the group consisting of aromatic polyesters, acrylate polymers, polystyrene, poly(methyl methacrylate), polyethylene glycol dimethacrylate, polystyrene/poly(divinylbenzene), polymer-lipids, polydimethylsiloxane, polyethyleneglycol, fluoropolymers, PVA polymers, and combinations thereof.
